(19) United States
(12) Patent Application Publication
(10) Pub. No.: US 2024/0056207 A1
(43) Pub. Date: Feb. 15, 2024

(54) Audio broadcasting methods and devices

(71) Applicant: Zgmicro Wuxi Corporation, Wuxi Jiangsu (CN)

(72) Inventor: Bin XU, Wuxi (CN)

(21) Appl. No.: 18/233,179

(22) Filed: Aug. 11, 2023

(30) Foreign Application Priority Data
Aug. 11, 2022 (CN) 202210963235.5

(51) Int. Cl. H04H 20/18; H04H 20/71; H04H 20/88

(52) U.S. Cl. CPC H04H 20/18; H04H 20/71; H04H 20/88

(57) ABSTRACT

A method, a device, and a system for broadcasting audio are described. The method is applied to a master device, and the method comprises: receiving, by the master device, a first audio data packet broadcast by a target slave device based on a reverse link in one or more reverse link time slots, one or more of the sub-event time slots being configured as the one or more reverse link time slots when the reverse link is enabled; and broadcasting, by the master device, a second audio data packet based on a forward link in one or more forward link time slots, one or more of the sub-event time slots used as one or more forward link time slots when the forward link is enabled, wherein at least one of the sub-event time slots is used as the reverse link time slot and the forward link time slot respectively in two isochronous intervals. In this way, a bi-directional communication between the master device and a slave device can be realized.

### CROSS-REFERENCE OF RELATED APPLICATIONS

The present invention claims priority of Chinese Patent Application No. 202210963235.5 filed in China on Aug. 11, 2022, the entire contents of which are incorporated herein by reference.

### BACKGROUND OF THE INVENTION

### Field of the Invention

The present invention relates to the field of wireless communication technology, and in particular to an audio broadcasting method, an audio broadcasting device, an audio broadcasting system.

### Description of the Related Art

With continuous development of wireless audio technology, the wireless audio technology has been widely used. For example, a Bluetooth Low Energy (BLE) Audio technology provides a Broadcast Isochronous Stream (BIS) link that realizes point-to-multipoint unidirectional audio transmission, which is widely used in wireless teaching systems. Teachers and multiple students can realize one-to-many teaching mode through the BIS link through the wireless teaching systems.

However, at present, the data on the BIS link can only be broadcasted from a master device to multiple slave devices in a one-to-many unidirectional way, and it is difficult for the data of any slave device to be transmitted back to the master device or to other slave devices through the BIS link. In a practical application, it is difficult for a teacher to receive feedback from students in time when the BIS link is applied in wireless teaching system.

### SUMMARY OF THE INVENTION

The purpose of the present invention is to provide an audio broadcasting method, an audio broadcasting device, an audio broadcasting system, an electronic device, and a readable storage medium to solve the problem that data of a slave device is difficult to be transmitted back to a master device or to other slave devices through a BIS link.

To achieve the purpose, according to one aspect of the present invention, a method for broadcasting audio is provided. The method is applied to a master device communicating with at least one slave device based on a plurality of isochronous intervals each comprising a plurality of sub-event time slots for broadcasting audio data packets. The method comprises: receiving, by the master device, a first audio data packet broadcast by a target slave device based on a reverse link in one or more reverse link time slots, the target slave device being one of the at least one slave device that has been allowed by the master device to access the reverse link, one or more of the sub-event time slots in the isochronous interval being used as the one or more reverse link time slots, when the reverse link is enabled; and broadcasting, by the master device, a second audio data packet based on a forward link in one or more forward link time slots, one or more of the sub-event time slots in the isochronous interval used as one or more forward link time slots, when the forward link is enabled. At least one of the sub-event time slots is used as the reverse link time slot and the forward link time slot respectively in two isochronous intervals.

According to another aspect of the present invention, a method for broadcasting audio is provided. The data transmission method is applied to a slave device communicating with a master device based on a plurality of isochronous intervals each comprising a plurality of sub-event time slots. The method comprises: broadcasting a first audio data packet broadcast by a target slave device based on a reverse link in one or more reverse link time slots after one of at least one slave device accesses the reverse link as the target slave device, the target slave device being one of the at least one slave device that has been allowed by the master device to access the reverse link, one or more of the sub-event time slots in the isochronous interval being used as the one or more reverse link time slots, when the reverse link is enabled; receiving a second audio data packet broadcast by the master device based on a forward link in one or more forward link time slots, one or more of the sub-event time slots in the isochronous interval used as one or more forward link time slots, when the forward link is enabled. At least one of the sub-event time slots is used as the reverse link time slot and the forward link time slot respectively in two isochronous intervals.

According to yet another aspect of the present invention, an audio broadcasting device is provided. The audio broadcasting device is a master device communicating with at least one slave device based on a plurality of isochronous intervals each comprising a plurality of sub-event time slots.

The audio broadcasting comprises: a first module for receiving a first audio data packet broadcast by a target slave device based on a reverse link in one or more reverse link time slots, the target slave device being one of the at least one slave device that has been allowed by the master device to access the reverse link, one or more of the sub-event time slots in the isochronous interval being used as the one or more reverse link time slots, when the reverse link is enabled; a second module for broadcasting a second audio data packet based on a forward link in one or more forward link time slots, one or more of the sub-event time slots in the isochronous interval being used as one or more forward link time slots, when the forward link is enabled. At least one of the sub-event time slots is used as the reverse link time slot and the forward link time slot respectively in two isochronous intervals.

In one embodiment of the present invention, a method for broadcasting audio is provided, wherein the master device and the slave devices may realize a bidirectional broadcast transmission of audio data through the time division multiplexing of the forward link and the reverse link. When the reverse link is enabled, the slave device accessing the reverse link may broadcast the first audio data packet in the reverse link time slot, and the master device and other slave devices not accessing the reverse link may receive the first audio data packet. When the forward link is enabled, the master device may broadcast the second audio data packet to all slave devices in the forward link time slots. Moreover, at least one sub-event time slot is used as the reverse link time slot and the forward link time slot respectively in two isochronous intervals, thereby realizing time division multiplexing of communication time for the forward link and the reverse link. Therefore, relative to the prior art, the present invention not only realizes bi-directional wireless audio data broadcast transmission, but also has the advantage of efficient use of time resources.

There are many other objects, together with the foregoing attained in the exercise of the invention in the following description and resulting in the embodiment illustrated in the accompanying drawings.

### BRIEF DESCRIPTION OF THE DRAWINGS

These and other features, aspects, and advantages of the present invention will become better understood with regard to the following description, appended claims, and accompanying drawings wherein:

FIG. 1 is a flowchart of a method for broadcasting audio provided according to one embodiment of the present invention;

FIG. 2 is a schematic diagram of a time slot structure of an isochronous interval provided according to one embodiment of the present invention;

FIG. 3 is a schematic diagram of a load format of a first control data packet provided according to one embodiment of the present invention;

FIG. 4 is a schematic diagram of a packet header structure of a data packet provided according to one embodiment of the present invention;

FIG. 5 is a schematic diagram of a time slot structure of an isochronous interval provided according to another embodiment of the present invention;

FIG. 6 is a schematic diagram of a master device provided according to one embodiment of the present invention;

FIG. 7 is a flowchart of a method for broadcasting audio provided according to one embodiment of the present invention;

FIG. 8 is a schematic diagram of a slave device provided according to one embodiment of the present invention;

FIG. 9 is a flowchart of a data packet transmitting and receiving process of a master device provided according to one embodiment of the present invention;

FIG. 10 is a flow chart of a data packet transmitting and receiving process of a slave device provided according to one embodiment of the present invention;

FIG. 11 is a schematic diagram of an audio broadcasting system provided according to one embodiment of the present invention;

FIG. 12 is a flowchart of a method for broadcasting audio provided according to one embodiment of the present invention;

FIG. 13 is a schematic diagram of an audio broadcasting device provided according to one embodiment of the present invention;

FIG. 14 is a schematic diagram of an audio broadcasting device provided according to another embodiment of the present invention; and

FIG. 15 is a schematic diagram of an electronic device provided according to one embodiment of the present invention.

### DETAILED DESCRIPTION OF THE PREFERRED EMBODIMENTS

The detailed description of the invention is presented largely in terms of procedures, operations, logic blocks, processing, and other symbolic representations that directly or indirectly resemble the operations of data processing devices that may or may not be coupled to networks. These process descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be comprised in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

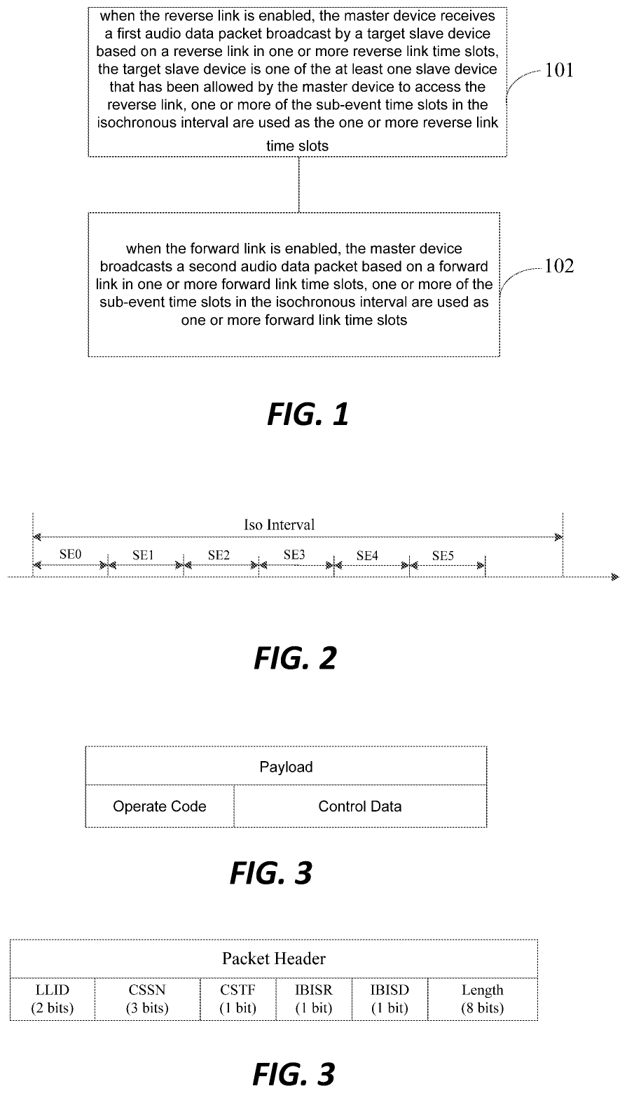

FIG. 1 is a flowchart of a method for broadcasting audio provided according to one embodiment of the present invention. As shown in FIG. 1, the method for broadcasting audio is applied to a master device communicating with at least one slave device based on a plurality of isochronous intervals (Iso Interval). Each Iso Interval comprises a plurality of sub-event (SE) time slots. The method for broadcasting audio comprises following operations.

At 101, when the reverse link is enabled, the master device receives a first audio data packet broadcast by a target slave device based on a reverse link in one or more reverse link time slots, the target slave device is one of the at least one slave device that has been allowed by the master device to access the reverse link, one or more of the sub-event time slots in the isochronous interval are used as the one or more reverse link time slots.

At 102, when the forward link is enabled, the master device broadcasts a second audio data packet based on a forward link in one or more forward link time slots, one or more of the sub-event time slots in the isochronous interval are used as one or more forward link time slots. At least one of the sub-event time slots is used as the reverse link time slot and the forward link time slot respectively in two isochronous intervals.

It can be understood that in the process of isochronous communication, a communication time is typically divided into a number of isochronous intervals when predefining a time slot structure of the isochronous communication. The communication time in each Isochronous Interval is divided into a plurality of sub-event (SE) time slots, and one audio data packet is transmitted within one sub-event time slot. In addition, the communication time in the isochronous intervals may be divided into time slots for transmitting other communication information, such as a control time slot for transmitting control information, a synchronization time slot for transmitting synchronization information, and the like.

For convenience of description, in subsequent embodiments, the sub-event time slots in the isochronous interval that would be used as the reverse link time slot and the forward link time slots respectively when different links are enabled are called as common sub-event time slots, and the number of common sub-event time slots is at least one.

It is noted that operations 101 and 102 are operations performed by the master device in the case of enabling different links. The number of isochronous intervals is multiple. In a specific implementation, an execution order between the operation 101 and the operation 102 may be in any order depending on switching of the forward link and the reverse link.

For example, in one case, during one isochronous interval, the forward link is enabled first, the master device executes the operation 102, and then the reverse link is enabled, and the master device executes the operation 101. In another case, during a previous isochronous interval of the current isochronous interval, the forward link is enabled, and the master device executes the operation 102, and therefore, the reverse link may be enabled first during the current isochronous interval, and the master device executes the operation 101, and then the forward link is enabled, and the master device executes the operation 102.

When the reverse link is enabled, the master device allows the target slave device to access the reverse link, and thus the master device may receive the first audio data packet broadcast by the target slave device based on the reverse link in the reverse link time slot. In one embodiment, the first audio data packet is an audio data packet configured to carry audio data of the target slave device.

When the forward link is enabled, the master device broadcasts the second audio data packets based on the forward link in the forward link time slots. In one embodiment, the second audio data packet is an audio data packet configured to carry audio data of the master device. Since at least one of the sub-event time slots is used as the reverse link time slot when the reverse link is enabled, and at least one of the sub-event time slots is used as the forward link time slot when the forward link is enabled. Thus, in one embodiment, there exists at least one common sub-event time slot that is used as the reverse link time slot in one isochronous interval when the reverse link has been enabled, and is used as the forward link time slot in the isochronous interval when the reverse link is not enabled (or the forward link is enabled).

For ease of understanding, a specific embodiment will be illustrated below. In a time slot structure of the isochronous interval as shown in FIG. 2, the number of SE time slots is 6, and the 6 SE time slots are denoted as SE0, SE1, SE2, SE3, SE4, and SE5, respectively. At least one of the 6 SE time slots is used as the forward link time slot in the Iso Interval when the forward link is enabled, and used as the reverse link time slot in the Iso Interval when the reverse link is enabled.

For example, in the first case, SE0, SE1, SE2, SE3, SE4, and SE5 are all common SE time slots that can be used as the forward link time slots in the Iso Interval when the forward link is enabled and used as the reverse link time slots in the Iso Interval when the reverse link is enabled.

In the second case, at least one SE time slot of the 6 SE time slots can be used as the forward link time slot only, and the remaining SE time slots of the 6 SE time slots can be used as the common SE time slots. For example, SE0 may be used as the forward link time slot only, and SE1, SE2, SE3, SE4, and SE5 are all the common SE time slots. Therefore, in the second case, the forward link time slots comprise SE0, SE1, SE2, SE3, SE4, SE5 when the forward link is enabled, and the reverse link time slots comprise SE1, SE2, SE3, SE4, SE5 when the reverse link is enabled.

In the third case, at least one SE time slot of the 6 SE time slots can be used as the forward link time slot only, at least one SE time slot of the 6 SE time slots can be used as the reverse link time slot only at the same time, and all of the remaining SE time slots can be used as the common SE time slots. For example, SE0 and SE1 may be used as the forward link time slots only, SE5 may be used as the reverse link time slot only, and SE2, SE3, and SE4 may all be used as the common SE time slots. Therefore, in the third case, the forward link time slots comprise SE0, SE1, SE2, SE3, SE4 when the forward link is enabled, and the reverse link time slots comprise SE2, SE3, SE4, SE5 when the reverse link is enabled.

It should be noted that, in a specific implementation, the number of SE time slots comprised in the forward link time slots when the forward link is enabled and the number of SE time slots comprised in the reverse link time slot when the reverse link is enabled may be the same or different. Furthermore, the number of SE time slots comprised in the forward link time slots may be greater or less than the number of SE time slots comprised in the reverse link time slots.

Optionally, in one embodiment, N sub-event time slots are comprised in one isochronous interval, and N is a positive integer.

First X sub-event time slots in the N sub-event time slots within one isochronous interval are used as the forward link time slots and last N-X sub-event time slots in the N sub-event time slots within the one isochronous interval are used as the reverse link time slots when the reverse link is enabled, wherein X is a positive integer less than N. The master device switches to the reverse link to receive the first audio data packet broadcast by the target slave device based on the reverse link after broadcasting the second audio data packet based on the forward link in the first X sub-event time slots.

Accordingly, the target slave device accessing the reverse link switches to the reverse link to broadcast the first audio data packet based on the reverse link in the last N-X sub-event time slots after receiving the second audio data packet based on the forward link in the first X sub-event time slots. Other slave devices that do not access the reverse link receive the second audio data packet broadcast by the master device in the first X sub-event time slots and receives the first audio data packet broadcast by the target slave device in the last N-X sub-event time slots.

When the forward link is enabled, the master device broadcasts the second audio data packet in the N sub-event time slots based on the forward link. Accordingly, all the slave devices receive the second audio data packet in the N sub-event time slots based on the forward link.

In one embodiment, when the reverse link is enabled, the target slave device accessing the reverse link may broadcast the first audio data packet to the master device and other slave devices not accessing the reverse link. When the forward link is enabled, the master device may broadcast the second audio data packet to all the slave devices. By switching between the reverse link and the forward link, a bidirectional broadcast transmission of audio data between the master device and the slave devices can be realized. In addition, at least one sub-event time slot is used as the reverse link time slot and the forward link time slot respectively in two isochronous intervals. In the case where the number of sub-event time slots is limited, the time division multiplexing of the forward link and the reverse link can be realized by the above setting, which has the advantage of efficient use of time resources.

Optionally, in one embodiment, the isochronous interval further comprises a synchronization time slot. The method further comprises: the master device broadcasts a synchronization information in the synchronization time slot. The synchronization information is configured to synchronize the slave device with the master device.

It should be understood that in an audio broadcast communication system, the device transmitting broadcast information needs to pass relevant parameters of communication rules to the device receiving broadcast information through the synchronization information before broadcasting, so that once the device receiving the broadcast information searches for the synchronization information, it can obtain the communication rules through the synchronization information, e.g., determining a communication time, a communication frequency, a data verification method, a data encryption and decryption method and the like, thereby synchronizing with the device transmitting the broadcast information.

In one embodiment, the master device broadcasts an advertisement data packet carrying the synchronization information in the synchronization time slot. The master device may broadcast the advertisement data packet in the synchronization time slot in each isochronous interval, or may do so in part of the isochronous intervals. As a specific embodiment, the master device may broadcast the advertisement data packet once every the same number of isochronous intervals throughout the communication process, thereby achieving periodic provision of the synchronization information and facilitating periodic updating of the synchronization information by the slave devices.

Optionally, in one specific embodiment, the synchronization information may comprise a time slot structure and a channel information of the isochronous interval. After receiving the synchronization information, the slave device may follow the channel information under the time slot structure of the isochronous interval, receive the second audio data packet broadcast by the master device based on the forward link, receive the first audio data packet broadcast by the target slave device based on the reverse link, and broadcast the first audio data packet as the target slave device based on the reverse link.

The time slot structure of the isochronous interval may comprise: a starting point of the isochronous interval, an isochronous interval length, sub-event time slot information, control time slot information, synchronization time slot information, and the like. The channel information comprises frequency hopping parameters such as frequency hopping sequences, channel lists, and the like.

In one specific embodiment, the synchronization information also comprises clock synchronization information, check code, and other information necessary for the slave device to perform the broadcast communication. It can be understood that in the process of broadcasting communication, after establishing synchronization between a broadcasting receiver and a broadcasting transmitter, the channel on which the broadcasting transmitter broadcasts information can be predicted by following the channel information, so as to receive the broadcast information in time synchronization. The present invention does not specifically limit this.

In one embodiment, the master device determines the communication rules on each link, and the slave devices are synchronized with the master device. The forward link and the reverse link used for broadcasting audio data packets by the master and the slave devices use the same time slot structure and follow the same channel information. For example, the synchronization information may comprise indication information of the control time slot so that after the slave device is synchronized with the master device based on the synchronization information, control data packets can be sent and received in the control time slot. In other embodiments, the synchronization information may also comprise indication information of the sub-event time slots so that after the slave device is synchronized with the master device, the slave device may determine a start time point of the sub-event time slots, the number of sub-event time slots, and the situation of the common sub-event time slots in each isochronous interval, so as to send and receive the audio data packets at each sub-event time slot.

In one embodiment, the isochronous interval also comprises a synchronization time slot, and the method further comprises: the master device broadcast the synchronization information in the synchronization time slot, and the synchronization information is configured to synchronize the slave device with the master device. Through the setting of the synchronization time slot described above, each slave device can synchronize with the master device by means of the synchronization information after searching for the synchronization information, so that each slave device communicates with the master device by means of the same communication rules, and the forward link and the reverse link share the synchronization. Therefore, each device communicates according to the synchronization information provided by the master device when switching between the forward link and the reverse link, and does not need to resynchronize because of link switching or changes of the broadcast transmitter.

For example, the target slave device does not need to reconfigure the communication rules and resend the synchronization information before broadcasting the first audio data packet on the reverse link, and the master device and other slave devices do not need to resynchronize with the target slave device. It can be seen that the present invention can realize rapid switching between links and effectively maintain the stability of the network topology of an audio broadcast system and smoothness of the audio broadcast transmission. The shared synchronization of the forward link and the reverse link facilitates rapid switching between the forward link and the reverse link, and the master device and the slave device need not be resynchronized in the case of switching between the forward link and the reverse link, which improves the synchronization accuracy and convenience of the master device and the slave device.

The present embodiment also provides a method for accessing the reverse link by the slave device, so as to facilitate the master device to effectively control the slave device to access the reverse link and communication condition of the reverse link. In one embodiment, the isochronous interval may also comprise a control time slot for the master device and the slave devices to interact with control information to realize access permit to the reverse link, random access to the reverse link, termination of access to the reverse link, and other control functions of the target slave device. In another embodiment, the master and slave devices may interact control information via a bidirectional control link.

Optionally, in one embodiment, the isochronous interval further comprises a forward control time slot, and the method further comprises: the master device broadcasts a first control data packet in the forward control time slot. The first control data packet is configured to trigger at least one slave device to perform an operation of accessing the reverse link. In one embodiment, the first control data packet is a packet carrying a first control information. The first control information is configured to trigger at least one slave device to perform an operation of accessing the reverse link.

The first control data packet carries the first control information, so that the first control information is equivalent to a payload of the first control data packet. The slave device performs the operation of accessing the reverse link based on the first control information after receiving the first control data packet.

It should be noted that the execution of the operation of accessing the reverse link by the slave device based on the first control information does not mean that the slave device can access the reverse link. After the slave device performs the operation of accessing the reverse link, it may fail to access the reverse link or succeed in accessing the reverse link.

It should be understood that specific manner in which the slave device performs the operation of accessing the reverse link varies depending on a content of the first control information. In one embodiment, the operation of accessing the reverse link by the slave device can be performed by directly accessing the reverse link by the slave device in response to the first control information. In other embodiments, the operation of accessing the reverse link by the slave device can also be performed by requesting to access the reverse link by the slave device in response to the first control information. Optionally, in one embodiment, the first control data packet carries a first control information. A type of the first control information may be an access permit or a random access.

The first control data packet is configured to trigger one slave device to perform the operation of accessing the reverse link when the type of the first control information is the access permit. The first control data packet is configured to identify that a random access window of the master device is opened within a target time length, so as to trigger at least one slave device to perform the operation of accessing the reverse link within the target time length when the type of the first control information is the random access.

The master device may control the designated target slave device to access the reverse link by configuring the first control information, i.e., request one designated slave device to access the reverse link as the target slave device. The master device can also control the random access of the slave device, i.e., allows the slave devices to initiate a random access request and selects the slave device that initiates the random access request to access the reverse link.

In one embodiment, the first control information comprises: a first information being configured to indicate a type of the first control information, the type of the first control information being the access permit or the random access; a second information being configured to indicate identification information of the slave device that is allowed to access the reverse link when the type of the first control information is the access permit, and indicate the target time length for which the random access window is opened when the type of the first control information is the random access.

It should be understood that the identification information of the slave device is not limited. For example, in one embodiment, the identification information of the slave device may be a device address of the slave device. In other embodiments, the identification information of the slave device may be a device identity document (ID) of the slave device. When the type of the first control information is the random access, the second information is configured to indicate the target time length for opening the random access window. At this time, the second control information is configured to identify that the slave device may request access to the reverse link within the target time length.

For any one of the slave devices receiving the first control packet, the slave devices may determine whether to perform the operation of accessing the reverse link, such as transmitting a request for accessing the reverse link in the target time length for which the random access window is open. The master device will select one slave device from the slave devices requesting access to the reverse link and allow it to access the reverse link, and the slave device allowed to access the reverse link is the target slave device.

It should be understood that the specific manner of indicating the target time length for which the random access window is open is not limited herein. For example, in one embodiment, the second information comprises an effective time length, i.e., the second information is configured to indicate that the random access window is opened between moment 1 and moment 2. In other embodiments, the second information comprises a deadline, i.e., the second information is configured to indicate that the random access window is turned on at the current moment and turned off at the deadline.

For example, as shown in FIG. 3, in one embodiment, the first information may also be referred to as Operate Code (Opcode), and the second information may also be referred to as Control Data (CtrData). In one embodiment, a Payload of the first control data packet comprises two parts: Opcode and CtrData. In one embodiment, the Opcode occupies 1 byte and the CtrData occupies 0 bytes to 250 bytes. Depending on the content of the Opcode, the CtrData contains different contents.

For example, in one embodiment, it is preset that Opcode=0xE0 when the type of the first control information is the access permit, and Opcode=0xE1 when the type of the first control information is the random access. When Opcode=0xE0, the CtrData contains the identification information of the slave device that is allowed to access the reverse link, i.e., the device address of the slave device that occupies 6 bytes and is allowed to access the reverse link. When Opcod=0xE1, the CtrData contains the deadline occupying 2 bytes, which can be represented using lower 16 bits of an event counter. When the event counter is lower than the deadline indicated by the event counter, the slave device is allowed to request access to the reverse link.

Optionally, in one embodiment, the isochronous interval further comprises a reverse control time slot, wherein the slave device broadcasts a second control data packet in the reverse control time slot, and the master device receives the second control data packet sent by the slave device in the reverse control time slot. The second control data packet is configured at least for the slave device to request access to the reverse link.

When the type of the first control information is the random access, before the master device receives the first audio data packet broadcast by the target slave device based on the reverse link in the reverse link time slot, the method further comprises: the master device opens the random access window continues for the target time length, broadcasts the first control data packet carrying the first control information whose the type is the random access in the forward control time slot, receives the second control data packet broadcast by at least one slave device in the reverse control time slot. The second control data packet is a data packet carrying a second control information, and the second control information is configured to request access to the reverse link.

When the target time length is reached, the master device closes the random access window and determines the target slave device based on the second control information received from all slave devices. After determining the target slave device, the master device broadcasts the first control data packet in the forward control time slot. The first information of the first control data packet indicates that the type of the first control information is the access permit, and the second information of the first control data packet indicates the identification information of the target slave device that is allowed to access the reverse link.

It is noted that in one embodiment, the format of the second control information may refer to the format of the first control information. For example, the second control information comprises a third information and a fourth information. The third information is configured to indicate that the type of the second control information is an access request, and the fourth information is configured to indicate the identification information of the slave device requesting to access to the reverse link.

As a specific implementation, the master device may broadcast the first control data packet representing a random access command in the forward control time slot in each isochronous interval when the random access window is open. There may be a plurality of slave devices simultaneously receiving the first control data packet broadcast by the master device. Optionally, in one embodiment, after receiving the first control data packet, the slave device sends the second control data packet to the master device after delaying a predetermined time. Furthermore, after the slave device receives the first control data packet for the first time, the slave device receives the first control packet again and sends the second control packet to the master device after delaying the predetermined time.

It should be noted that the predetermined time corresponding to different slave devices is different, and the length of the predetermined time is less than the target time length so that the slave device can send the second control data packet before the random access window is closed. The predetermined time may also be a randomly generated delay time. With the above setting, different slave devices may send the second control packet to the master device at different times, thereby avoiding conflict of the second control packet sent by the plurality of slave devices and improving the reliability of the master device in receiving the second control packet.

In a specific implementation, the slave devices that receive the first control data packet may all send the second control data packet to the master device, or only some of the slave devices that receive the first control data packet may send the second control data packet to the master device. The master device may receive the second control data packets broadcast by the slave devices at the reverse control time slot in each isochronous interval when the random access window is open. When the target time length is reached, the master device closes the random access window. At this time, the master device no longer receives the second control data packet from the slave device and determines the target slave device based on the second control information of the received second control data packets.

It should be understood that specific methods for the master device to determine one slave device from the at least one slave device as the target slave device based on the second control information are not limited herein. For example, in one embodiment, the master device may determine the target slave device based on a temporal order of receipt of the second control data packets. In other embodiments, the master device may determine the target slave device based on predetermined rules.

After determining the target slave device, the master device broadcasts the first control data packet again in the forward control time slot. The type of the first control information of the first control data packet broadcast this time is the access permit, and the second information of the first control data packet indicates the identification information of the target slave device that is allowed to access the reverse link.

The target slave device may access the reverse link based on the first control data packet after receiving the above-described first control data packet, broadcast the first audio data packet based on the reverse link in the reverse link time slot, and the master device receives the first audio data packet based on the reverse link in the reverse link time slot. It is noted that other slave devices except for the target slave device may also receive the first audio data packet in the reverse link time slot.

Optionally, in one embodiment, when the type of the first control information is the access permit, the method further comprises: the master device broadcasts the first control data packet in the forward control time slot. The first information of the first control data packet indicates that the type of the first control information is the access permit, and the second information of the first control data packet indicates the identification information of the target slave device that is allowed to access the reverse link.

For any one of the slave devices receiving the first control data packet, the slave device determines whether the identification information of the slave device allowed to access the reverse link indicated by the second information of the first control data packet matches the identification information of this slave device. In the case of matching, this slave device confirms that it is the target slave device and may access the reverse link. In the case of mismatch, this slave device does not access the reverse link.

Optionally, in one embodiment, the first control information is also configured to control the target slave device to terminate access to the reverse link. When the reverse link is enabled, the method further comprises: the master device broadcasts the first control data packet in the forward control time slot. The first control data packet carries the first control information for controlling the target slave device to terminate access to the reverse link.

In one specific implementation, controlling the target slave device to terminate access to the reverse link may be to notify the target slave device to terminate communication on the reverse link if the target slave device has accessed the reverse link; or may also be to notify all slave devices that access to the reverse link is prohibited. Optionally, in one embodiment, the first control information for controlling the target slave device to terminate access to the reverse link, comprises: a first information indicating that the type of the first control information is the access termination, and a second information indicating a reason and/or an effective time of the access termination when the type of the first control information is the access termination.

In one embodiment, the type of the first control information may be the access permit, the random access or the access termination. When the type of the first control information is the access termination, the second information is configured to indicate a reason and/or an effective time of the access termination. In one embodiment, the second information may also be configured to indicate the reason of the access termination. The reason of the access termination is not limited herein. For example, in one embodiment, the reason of the access termination may be insufficient power for the master device and/or the slave device. In other embodiments, the reason of the access termination may be that the master device and/or the slave device are in a shutdown state.

It should be understood that specific method for indicating the effective time of the access termination is not limited herein. For example, in one embodiment, the second information is an effective moment, i.e., indicating that access to the reverse link by the target slave device is terminated at that effective moment. In other embodiments, the second information is an effective duration, i.e., indicating the termination of the enabled reverse link continues to be effective for a certain duration after the enabled reverse link is enabled.

Exemplarily, as shown in FIG. 3, it is predetermined that when the type of the first control information is the access termination, Opcode=0xD3. When Opcode=0xD3, the CtrData comprises the reason of the access termination occupying 1 byte and the effective time of the access termination occupying 2 bytes. Specifically, the effective time of the access termination may be represented by the low 16 bit of the event counter.

Optionally, in one embodiment, during the audio broadcast communication, the master device enables the forward link or the reverse link and broadcasts an indicator indicating that the forward link or the reverse link is enabled. In a specific implementation, the master device may transmit the indicator via the control data packet or other information packets, may broadcast the indicator in each isochronous interval, or may broadcast the indicator before allowing and terminating the transmission of the first audio data packet on the reverse link. The details may be set according to the actual application scenario.

In some implementations, the master device may periodically enable the reverse link automatically, or may receive an external input command to enable the reverse link. Optionally, a packet header of the second audio data packet comprises a first region for indicating that the forward link or the reverse link is enabled. The master device broadcasts the second audio data packet comprising the first region based on the forward link in the forward link time slot to notify the slave device that the reverse link or the forward link is enabled.

It is noted that in a specific implementation, the second audio data packet may or may not comprise audio data of the master device. When the second audio data carries the audio data of the master device, the second audio data packet may notify the slave device that the reverse link or the forward link is enabled while transmitting the audio data. When the second audio data packet does not carry the audio data of the master device, the second audio data packet notifies the slave device that the reverse link or the forward link is enabled only through the first region.

In one embodiment, the master device broadcasts the second audio data packet at least comprising the first region based on the forward link in the forward link time slot. Since the first region of the second audio data packet is configured to indicate whether the reverse link is enabled or not, the slave device receiving the second audio data packet may determine whether the reverse link or the forward link is enabled at this time based on the first region.

According to a specific implementation, the packet header of the second audio data packet comprises the first region (be known as Interactive Broadcast Isochronous Stream Reversed, IBISR) configured to indicate whether the reverse link is enabled. Exemplarily, in one implementation, when IBISR is assigned a value of 1, it indicates that the reverse link is enabled, and when IBISR is assigned a value of 0, it indicates that the reverse link is not enabled. In the specific implementation, the first region occupies 1 bit.

In view of the fact that the slave devices that do not access the reverse link may receive not only the second audio data packet broadcast by the master device, but also the first audio data packet broadcast by the target slave device. In one embodiment, the packet headers of the first audio data packet and the second audio data packet comprise a second region for representing a sender of the present audio data packet. I.e., when the master device and the target slave device generate the audio data packet, the second region is set to represent whether the audio data packet is sent by the master device or by the target slave device.

In one embodiment, the second region may also be referred to as an Interactive Broadcast Isochronous Stream Direction (IBISD) for representing a direction in which this audio packet is sent. Exemplarily, in one embodiment, when IBISD is assigned a value of 0, it indicates that the data packet is broadcasted from the master device to the slave device. When IBISD is assigned a value of 1, it indicates that the data packet is broadcasted from the target slave device to the master device and other slave devices.

Optionally, as shown in FIG. 4, in one embodiment, both the audio data packet and the control data packet may be generated based on a BLE BIS Protocol Data Unit (PDU). The BLE BIS PDU can also be abbreviated as a BIS PDU. That is, some packet header information is set on a structure of the BIS PDU so as to make it applicable to the audio data packets and the control data packets in the present invention. By using the packet header information in the original BIS PDU, it continues to be applicable to a BLE Broadcast Isochronous Group (BIG) system. This allows the methods, devices and systems in the present invention to be compatible with the BLE BIG systems under standard protocols.

The audio data packet is a packet of audio data for interaction between the master device and the slave device. The audio data packet comprises a first audio data packet and a second audio data packet. The control data packet is a packet of control information for interaction between the master device and the slave device. The control data packet comprises a first control data packet and a second control data packet. The packet header of the data packet generated based on the BIS PDU may further comprise the following packet header information in the BIS PDU: a Logical Link Identifier (LLID) for identifying a load type of this data packet; a Control Sub-event Sequence Number (CSSN) configured to identify a sequence number of the control data packet; a Control Subevent Transmission Flag (CSTF) for identifying whether the control data packet is transmitted at this isochronous interval; a Load Length identifier for identifying a load length of this data packet. When two bits of the LLID are set to 1, the current data packet is a control data packet.

In one embodiment, the forward link and the reverse link are both unidirectional wireless broadcast data links. The method of the present invention may also be referred to as a wireless point-to-multipoint interactive broadcast audio transmission method, and the communication link used for the present invention may be referred to as an Interactive Broadcast Isochronous Stream (IBIS) link. The master device and slave device communicate wirelessly based on the Interactive Broadcast Isochronous Stream (IBIS) link comprising the forward link and the reverse link.

In one embodiment, the audio data packet of audio data interacting between the master device and the slave devices is referred to as an IBIS PDU. In addition, the control data packet of control information interacting between the master device and the slave devices is referred to as an IBISC PDU (IBIS Control PDU). IBIS PDU and BIS PDU have the same structure but different packet header formats. IBISC PDU and BIS PDU have the same structure but different packet header formats. That is, the IBIS PDU and the IBISC PDU are BIS PDUs that use revised header. The specific methods for generating IBIS PDU and IBISC PDU based on BIS PDU are not limited herein. For example, in one embodiment, taking IBIS PDU as an example, based on the packet header of BIS PDU, IBIS PDU uses a reserved for Future Use (RFU) in the packet header of BIS PDU as the first region. In other embodiments, based on the packet header of BIS PDU, IBIS PDU uses another RFU in the packet header of BIS PDU as the second region.

In one embodiment, the packet header of the first audio data packet, the second audio data packet, the first control data packet, and the second control data packet generated based on the BIS PDU is shown in FIG. 4. The packet header of the IBIS PDU and the IBISC PDU comprises the LLID occupying 2bits, the CSSN occupying 3bits, the CSTF occupying 1 bit, the IBISR occupying 1 bit, IBISD occupying 1 bit, and Length occupying 8bits.

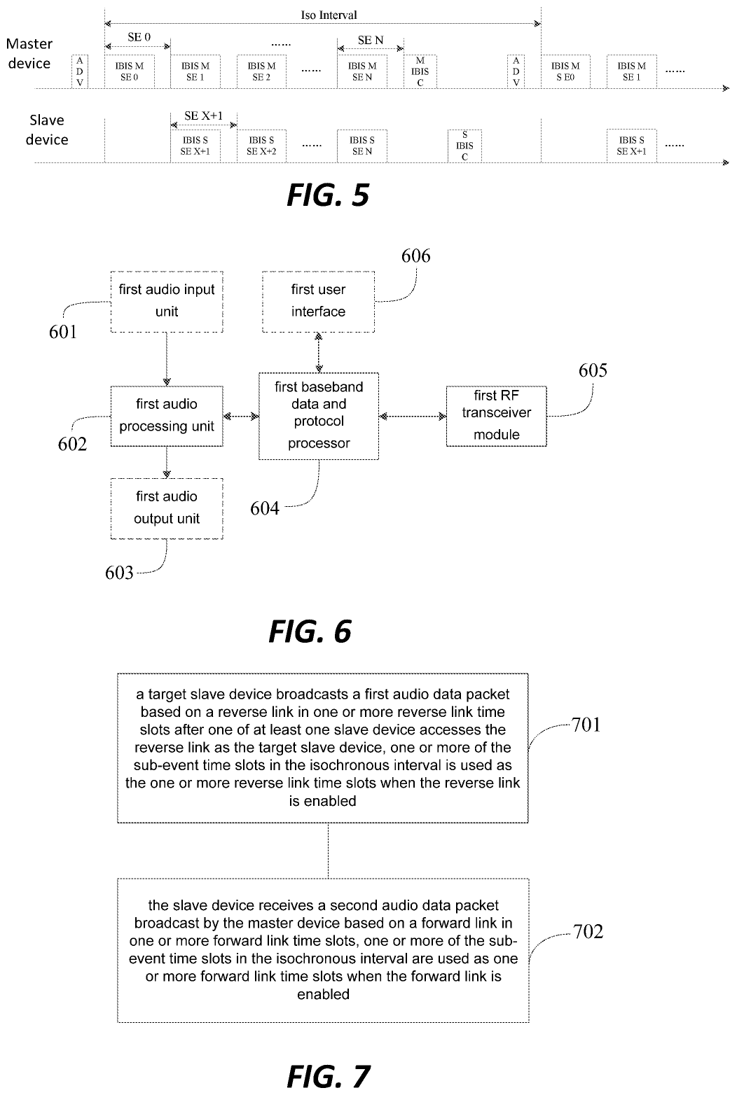

For ease of understanding, a process of audio broadcasting and a setting of the packet header parameter of the data packet will be described below by taking a specific time slot structure of the isochronous interval as an example. The time slot structure of the isochronous interval in the present embodiment is shown in FIG. 5. The upper diagram in FIG. 5 schematically illustrates the time slot structure of the isochronous interval of the master device, and the lower diagram in FIG. 5 schematically illustrates the time slot structure of the isochronous interval of the slave device.

In FIG. 5, N+1 sub-event time slots are comprised within one isochronous interval. The isochronous interval also comprises the synchronization time slot, the forward control time slot, and the reverse control time slot. The master device sends the advertisement data packet (ADVs shown in FIG. 5) carrying the synchronization information for all slave devices to synchronize with the master device at the synchronization time slot within one isochronous interval. When the forward link is enabled, the master device repeatedly sends the same IBIS PDU N+1 times to the slave device in the N+1 SE time slots used as the forward link time slots shown in FIG. 5 for transmitting the second audio data (as shown in IBIS M SE 0, IBIS M SE 1, . . . , IBIS M SE N in FIG. 5).

Both IBISR and IBISD in the packet header of IBIS PDU are set to 0. It should be noted that each SE time slot is configured to send one IBIS PDU. The master device may also send IBISC PDUs for transmitting the first control information in the forward control time slot (e.g., M IBISC as illustrated in FIG. 5). Before transmitting the IBISC PDU, the master device sets the CSTF in the IBIS PDU packet header to 1 to notify the slave devices to receive the IBISC PDU in the forward control time slot within the current Iso Interval. In addition, the master device may also receive IBISC PDU sent by the slave device in the reverse control time slot.

When the forward link is enabled, the slave device that have received ADV PDUs and synchronized with the master device receives IBIS PDUs sent by the master device at least once until the IBIS PDUs sent by the master device are correctly received or the number of reception times reaches N+1. The slave device receives the IBISC PDU sent by the master device based on the CSTF in the IBIS PDU packet header sent by the master device. When the type of the first control information carried by the IBISC PDU is the random access, the slave device can reply to the IBISC PDU based on the first control information carried by the IBISC PDU (e.g., S IBISC as shown in FIG. 5).

When the reverse link is enabled, the master device repeatedly sends IBIS PDUs X+1 times to the slave device over the forward link, passes information such as IBISR, ISISD, and CSTF through the packet header of the IBIS PDU, wherein IBISR is set to 1 and ISISD is set to 0. In one specific embodiment, the load length of the IBIS PDU sent by the master device may be 0, i.e., no load. The master device may also send the IBISC PDU for transmitting the first control information and set the CSTF in the packet header of the IBIS PDU data packet to 1 before transmitting the IBISC PDU. After transmitting the X+1st IBIS PDU, the master device switches to the reverse link and receives the IBIS PDUs sent by the slave devices based on the reverse link in the SE time slots used as the reverse link time slots. The master device can switch quickly because the forward link and the reverse link share synchronization.

When the reverse link is enabled, the slave device synchronized based on the ADV PDU receives the IBIS PDUs sent by the master device at least once or at most X+1 times. On one hand, the slave device can correct a local Bluetooth clock according to the received IBIS PDU time to obtain accurate synchronization, and on the other hand, it can also obtain IBISR and CSTF information. The slave device receives the IBISC PDU sent by the master device based on the CSTF in the packet header in the received IBIS PDU sent by the master device. When the type of the first control information carried by the IBISC PDU sent by the master device is the random access, the slave device may reply to the IBISC PDU based on the first control information carried by the IBISC PDU. On the one hand, if IBISR is set to 1, the target slave device switches to the reverse link and thus sends the IBIS PDU for transmitting the first audio data in the SE time slots used as the reverse link time slots (as shown in FIG. 5 for IBIS S SE X+1, IBIS S SE X+2, IBIS S SE N), 0≤X≤(N−1), wherein both IBISR and IBISD in the packet header of the IBIS PDU packet sent by the target slave device are set to 1. After completing the broadcast and reception of the first audio data packet on the reverse link, the target slave device then switches to the forward link to receive the IBIS PDUs that were sent by the master device during the first X+1 SE time slots in the next Iso Interval. On the other hand, if IBISR is set to 1, other slave devices except for the target slave device receive the IBIS PDUs sent by the target slave device in the SE time slots that are used as the reverse link time slots. Since the forward link and the reverse link share synchronization, the other slave devices that do not access the reverse link only need to continuously receive the audio data packets based on the synchronization information.

It should be noted that in the specific implementation, in addition to the SE time slot, the synchronization time slot, the forward control time slot and the reverse control time slot, other time slots may be comprised within the Iso Interval as shown in FIG. 5, and the other time slots may be time slots that are not in use or may be used for other wireless connections. The specific structure of the master device is not limited herein. As shown in FIG. 6, in one embodiment, the master device comprises a first audio input unit 601, a first audio processing unit 602, a first audio output unit 603, a first baseband data and protocol processor 604, a first RF transceiver module 605, and a first user interface 606.

Specifically, the first audio input unit 601 may be a microphone or a wireless microphone, and the first audio input unit 601 is configured to capture external audio signals, voice or vocal music, and convert them into digital audio signals. A first audio transmission unit is wired or wirelessly connected to the first audio processing unit 602 for transmitting the converted digital audio signal to the first audio processing unit 602.

The first audio processing unit 602 is configured to convert the digital audio signals captured by the first audio input unit 601 into audio data after processing such as noise cancellation, sound effects, and audio coding to facilitate wireless transmission when the forward link is enabled. The first audio processing unit 602 is also configured to process the audio data parsed by the first baseband data and protocol processor 604, including decoding, packet loss concealment, equalization and sound effects, and other processing, before converting to digital audio signals.

The first audio output unit 603 may be a speaker for converting the digital audio signal processed by the first audio processing unit 602 into sound. The first user interface 606 is connected to the first baseband data and protocol processor 604 for operating or controlling the master device, inputting interaction commands, and outputting status information. The first user interface 606 may comprise a button, an indicator light, or a voice command recognition unit.

The first baseband data and protocol processor 604 is configured to execute the IBIS link protocol, generate synchronization information, the second audio data packet, and the first control data packet, receive and process the first audio data packet and the second control data packet, and also process commands input by the first user interface 606 and provide status information to the first user interface 606.

The first RF transceiver module 605 is configured to modulate the synchronization information, the second audio data packet and the first control data packet into RF signals and transmit them, or configured to receive the RF signals and demodulate them into the first audio data packet and the second control data packet. As shown in FIG. 7, a method for broadcasting audio provided according to one embodiment of the present invention can be applied to the slave device. The slave device communicates with the master device based on a plurality of isochronous intervals. Each isochronous interval comprises a plurality of sub-event time slots. The method comprises the following operations.

At 701, a target slave device broadcasts a first audio data packet based on a reverse link in one or more reverse link time slots after one of at least one slave device accesses the reverse link as the target slave device, the target slave device is one of the at least one slave device that has been allowed by the master device to access the reverse link, one or more of the sub-event time slots in the isochronous interval is used as the one or more reverse link time slots when the reverse link is enabled.

At 702, the slave device receives a second audio data packet broadcast by the master device based on a forward link in one or more forward link time slots, one or more of the sub-event time slots in the isochronous interval are used as one or more forward link time slots when the forward link is enabled. At least one of the sub-event time slots is used as the reverse link time slot and the forward link time slot respectively in two isochronous intervals. When the reverse link is enabled, the slave device broadcasts the first audio data packet based on the reverse link in the reverse link time slots after the slave device has accessed the reverse link as the target slave device, the target slave device is the slave device that has been allowed to access the reverse link by the master device. When the slave device does not access the reverse link, the slave device receives the first audio data broadcast in the reverse link time slot based on the reverse link by the target slave device that has accessed the reverse link.

When the forward link is enabled, the master device broadcasts the second audio data packet in the forward link time slot based on the forward link, and all slave devices may receive the second audio data packet broadcast by the master device based on the forward link. It should be understood that this embodiment, as one implementation of a slave device side corresponding to the embodiments shown in FIG. 1, can be implemented as described in the embodiments shown in FIG. 1, and will not be repeated herein to avoid repetition. Optionally, in one embodiment, the method further comprises: the slave device searches for synchronization information broadcast by the master device and synchronizes with the master device based on the synchronization information; the slave device receives the second audio data packet based on the synchronization information; the slave device broadcasts the first audio data packet based on the synchronization information when the slave device accesses the reverse link as the target slave device when the reverse link is enabled, or, the slave device receives the first audio data packet broadcast by the target slave device based on the synchronization information when the slave device does not access the reverse link. It can be seen that the present invention can also achieve broadcast communication between different slave devices without the need for resynchronization. Optionally, in one embodiment, the synchronization information comprises a time slot structure information and a channel information of the isochronous interval.

When the reverse link is enabled, the slave device that does not access the reverse link receives the first audio data packet broadcast by the target slave device based on the reverse link in the reverse link time slot. In one embodiment, the isochronous interval further comprises a forward control time slot, wherein the slave device receives a first control data packet broadcast by the master device in the forward control time slot and performs an operation of accessing the reverse link or performs an operation of terminating the reverse link based on the first control information carried by the first control data packet. It should be understood that depending on the first control information carried by the first control data packet, the specific way in which the slave device performs the operation of accessing the reverse link, or the specific way in which the slave device performs the operation of terminating the reverse link, is different.

As can be seen from the foregoing description, the first control information comprises a first information and a second information, the first information is configured to indicate a type of the first control information. When the type of the first control information is different, the second information corresponding thereto is also different. For example, in a first case, the type of the first control information is an access permit, and the second information indicates identification information of the slave device that is allowed to access the reverse link. In this case, the slave device determines whether the identification information of the slave device that is allowed to access the reverse link indicated by the second information of the first control data packet matches the identification information of this slave device. In the case of matching, the slave device performs the operation of accessing the reverse link. In the case of mismatch, the slave device does not perform the operation of accessing the reverse link.

In a second case, the type of the first control information is a random access and the second information is configured to indicate a target time length for which the random access window is open. In this case, the slave device may perform the operation of accessing the reverse link or not perform the operation of accessing the reverse link. In one embodiment, the isochronous interval further comprises a reverse control time slot, wherein the slave device sends a second control data packet in the reverse control time slot. The second control data packet is a data packet carrying a second control information, and the second control information is configured to request access to the reverse link, or to request termination of the reverse link.

Specifically, in one embodiment, the isochronous interval further comprises the reverse control time slot. When the slave device performs the operation of accessing the reverse link, the slave device broadcasts the second control data packet in the reverse control time slot, the second control data packet is a packet carrying a second control information, and the second control information is configured for requesting access to the reverse link. It is noted that in one embodiment, the type of the second control information may be an access request, and the second control information further comprises identification information of the slave device.

Exemplarily, as shown in FIG. 3, it is predetermined that Opcode=0xD2 when the type of the second control information is the access request. When Opcode=0xD2, the CtrData comprises identification information of the slave device, which can be a device address of the slave device occupying 6 bytes. In a third case, the type of the first control information is the access termination, and the second information indicates the reason and/or the effective time of the access termination. In this case, if the slave device has accessed the reverse link as the target slave device, the slave device stops broadcasting the first audio data packet on the reverse link and the slave device switches from the reverse link to the forward link. If the slave device does not access the reverse link, the slave device does not perform any operation to access the reverse link. Optionally, in one embodiment, the packet header of the first audio data packet and the second audio data packet comprises a second region for representing the sender of this audio data packet.

The slave device determines whether the received audio data packet is the second audio data packet sent by the master device or the first audio data packet sent by the target slave device based on the second region. The packet header of the first audio data packet and the second audio data packet comprises the second region. In one embodiment, the packet header of the first audio data packet further comprises a first region for representing whether the reverse link is enabled. In other embodiments, the packet header of both the first audio data packet and the second audio data packet comprises the first region.

In one embodiment, if IBISD is set to 0, it indicates that the sender of this data packet is the slave device, and if IBISD is set to 1, it indicates that the sender of this data packet is the master device. When the second audio data packet comprises the second region, the slave device may determine that the second audio data packet is sent by the master device based on the second region of the second audio data packet. When the first audio data packet comprises the second region, the slave device that does not access the reverse link may determine that the one audio data packet is sent by the target slave device based on the second region of the first audio data packet. Optionally, in one embodiment, N sub-event time slots are comprised within one isochronous interval, and N is a positive integer.

The first X sub-event time slots in the N sub-event time slots within one isochronous interval are used as the forward link time slots and the last N-X sub-event time slots in the N sub-event time slots within the one isochronous interval are used as the reverse link time slots when the reverse link is enabled, wherein X is a positive integer less than N. The slave device accessing the reverse link as the target slave device receives the second audio data packet based on the forward link during the first X sub-event time slots, then switches to the reverse link and broadcasts the first audio data packet based on the reverse link in the last N-X sub-event time slots. The slave devices that do not access the reverse link receive the second audio data packet broadcasted by the master device in the first X sub-event time slots, and receive the first audio broadcasted by the target slave device in the last N-X sub-event time slots. When the forward link is enabled, the slave device receives the second audio packet broadcast by the master device in the N sub-event time slots based on said forward link.

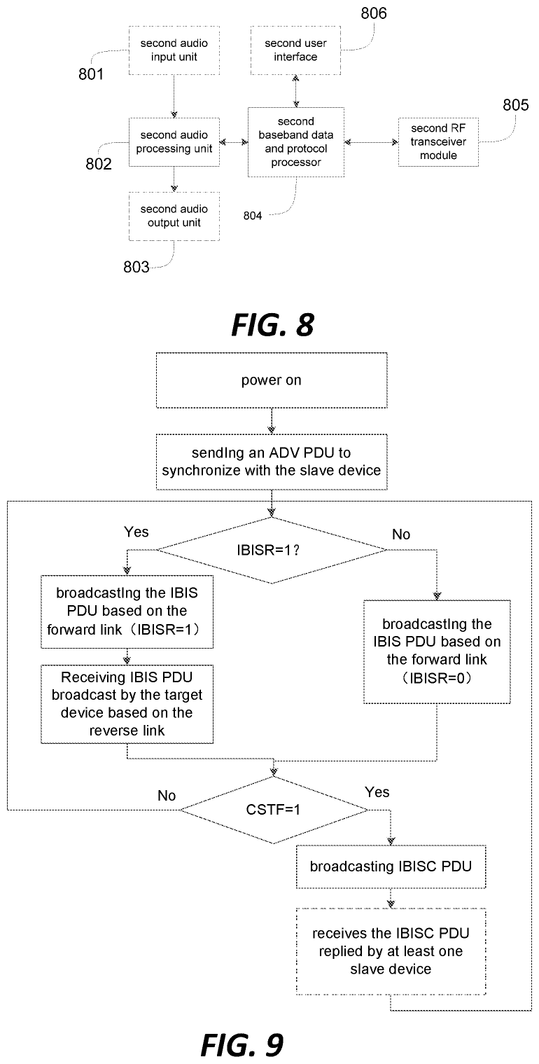

It should be understood that the above embodiment, as one implementation of the slave device side corresponding to the embodiments shown in FIG. 1, can be implemented as described in the embodiments shown in FIG. 1, and will not be repeated herein to avoid repetition. A specific structure of the slave device is not limited herein. As shown in FIG. 8, in one embodiment, the slave device comprises a second audio input unit 801, a second audio processing unit 802, a second audio output unit 803, a second baseband data and protocol processor 804, a second RF transceiver module 805, and a second user interface 806. Specifically, the second audio input unit 801 may be a microphone, and the second audio input unit 801 is configured to capture external audio signals, convert it to digital audio signals and transmit it to the second audio processing unit 802.

When the reverse link is enabled, the second audio processing unit 802 is configured to convert the digital audio signal captured by the second audio input unit 801 into audio data after processing such as noise cancellation, sound effect, and audio coding to facilitate wireless transmission. When the forward link is enabled, the second audio processing unit 802 is also configured to process the audio data parsed by the second baseband data and protocol processor 804, including decoding, packet loss concealment, equalization, and sound effects, and other processing, before converting it into digital audio signals.

The second audio output unit 803 may be a loudspeaker for converting the digital audio signals processed by the second audio processing unit 802 into sound. The second user interface 806 is connected to the baseband data and protocol processor for operating or controlling the slave device, inputting interaction commands, and outputting status information. The second user interface 806 may comprise buttons, indicator lights, etc. The second baseband data and protocol processor 804 executes the IBIS link protocol, generates the first audio data packet and the second control data packet, receives and processes the synchronization information, the second audio data packet and the first control data packet, and also processes commands input by the second user interface 806, and provides status information to the second user interface 806.

The second RF transceiver module 805 is configured to modulate the first audio data packet and the second control data packet into RF signals and transmit them, or to receive the RF signals and demodulate them into the synchronization information, the second audio data packet and the first control data packet. For ease of understanding, specific embodiments will be exemplified below.

Referring to FIG. 9, a data packet transmitting and receiving process of the master device will be described below. In actual use, after the master device is powered on, it first sends an ADV PDU to synchronize with the slave device. The master device sets the IBISR of the IBIS PDU to 0, which indicates that the reverse link is not enabled, and then the master device broadcasts the IBIS PDU based on the forward link in the SE time slots used as the forward link time slots. Alternatively, the master device sets the IBISR of the IBIS PDU to 1, which indicates that the reverse link is enabled, and the master device transmits the IBIS PDU and then receives the IBIS PDU broadcast by the target slave device in the SE time slots used as the reverse link time slots. In one case, the master device can send the IBISC PDU. In this case, the master device sends the IBISC PDU after setting the CSTF in the packet header of the sent IBIS PDU to 1. The master device receives the IBISC PDU replied by at least one slave device and then proceeds to the transmitting and receiving process in the next isochronous interval.

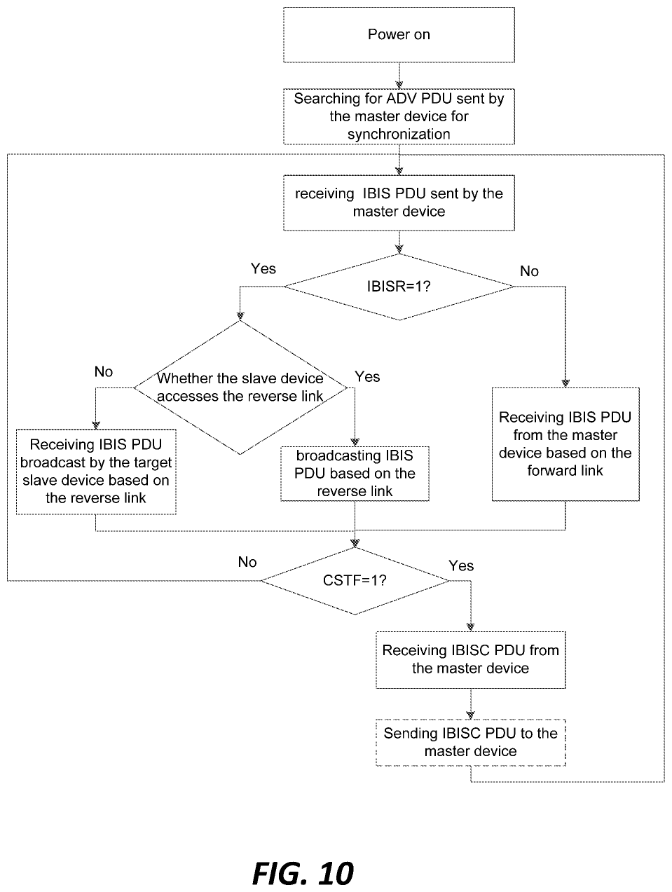

Refer to FIG. 10, a packet transmitting and receiving process of the slave device will be described below. In actual use, the slave device searches for ADV PDU sent by the master device to synchronize with the master device after the slave device is powered on. The slave device receives the IBIS PDU sent by the master device in each isochronous interval. When the IBISR in the packet header of the IBIS PDU is set to 0, the slave device continues to receive the IBIS PDUs broadcast by the master device based on the forward link in the SE time slots used as the forward link time slots. When the IBISR in the packet header of the IBIS PDU is set to 1 and the slave device is the target slave device accessing the reverse link, the target slave device broadcasts the IBIS PDU based on the reverse link in the SE time slots used as the reverse link time slots. When the IBISR in the packet header of the IBIS PDU is set to 1 and the slave device is not accessing the reverse link, the slave device receives the IBIS PDUs broadcasted by the target slave device in the SE time slots used as the reverse link time slots. After the slave device receives or broadcasts the IBIS PDU based on the forward link or the reverse link, if the CSTF in the packet header of the IBIS PDU sent by the master device is set to 1, the slave device receives the IBISC PDU and determines whether to send the IBISC PDU according to the payload carried by the IBISC PDU, then it goes into the next isochronous interval to continue to receive the IBIS PDU sent by the master device. If the CSTF in the packet header of the IBIS PDU sent by the master device is 0, the slave device directly enters the next isochronous interval to continue to receive the IBIS PDU sent by the master device.

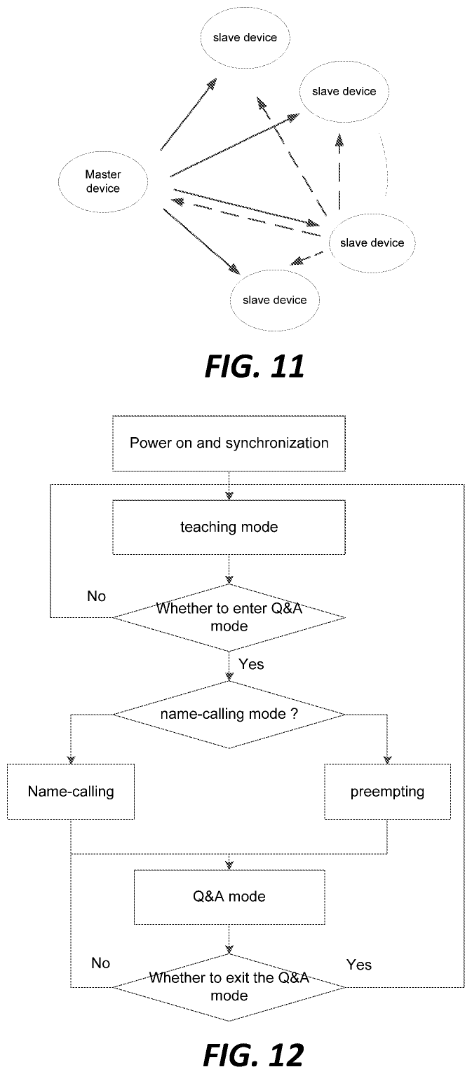

Referring to FIG. 11, an audio broadcasting system is provided according to one embodiment of the present invention. The system comprises: a master device as described in the above embodiments; and at least two slave devices as described in the above embodiments. Referring to FIG. 5-FIG. 6 and FIG. 8-FIG. 12, a specific flow of the method for broadcasting audio provided according to one embodiment of the present invention will be described below under an application scenario of the audio broadcasting system as a wireless teaching system as shown in FIG. 11. In this application scenario, the master device can be understood as a teacher head-mounted audio device, and the slave devices can be understood as student head-mounted audio devices. As shown in FIG. 11, the number of the teacher head-mounted audio device is one, and the number of the student head-mounted audio devices is multiple.

Both the teacher head-mounted audio device and the student head-mounted audio device comprise a microphone function for inputting audio and a headphone function for outputting audio. Teaching audio and student Q&A (question and answer) audio are sent and received over the IBIS link between the teacher head-mounted audio device and the student head-mounted audio devices.

The wireless teaching system as shown in FIG. 11 supports a teaching mode and a Q&A mode. In the teaching mode, the teacher head-mounted audio device sends audio data (second audio data packet) to all student head-mounted audio devices over the forward link. In the Q&A mode, any one (the target slave device) of the student head-mounted audio devices can send audio data (the first audio data packet) to the teacher head-mounted audio device and all other student head-mounted audio devices (the slave devices that do not access the reverse link) via the reverse link.

In one embodiment, the teacher head-mounted audio device uses the master device as shown in FIG. 6, and all student head-mounted audio devices use the slave devices as shown in FIG. 8. A mono microphone sampling rate of both the teacher head-mounted audio device and the student head-mounted audio device is 48 kHz, and the number of quantization bits is 16. A coding rate using Low Complexity Communication Codec (LC3) is 80 kbps, a frame length is 10 ms, and each service Data Unit (SDU) is 100 bytes in size.

In the time slot structure of the isochronous interval shown in FIG. 5, the IBIS isochronous interval is equal to 10 ms and BLE 2 Mbps transmission rate is used. Each IBIS PDU with audio load occupies 464 us of airtime, and each SE time slot is 650 us. The forward link is enabled in the teaching mode, and the number of the SE time slots used for the teacher head-mounted audio device to send IBIS PDUs is equal to 6, which occupies a total of 3.9 ms of air time. When the reverse link is enabled in the Q&A mode, the number of SE time slots used for the teacher head-mounted audio device to send IBIS PDUs is equal to 5, which occupying a total of 3.25 ms of air time.

Refer to FIG. 12, the teacher head-mounted audio device and the student head-mounted audio devices are powered on and synchronized before entering the teaching mode. Specifically, the teacher head-mounted audio device broadcasts an ADV PDU carrying synchronization information based on the forward link in the synchronization time slot, and the student head-mounted audio devices search for the ADV PDU and synchronize with the teacher head-mounted audio device based on the synchronization information.

During the teaching mode, the teacher can choose one student to enter the Q&A mode through two modes: a name-calling mode or a preempting mode. In this application scenario, the name-calling mode can be understood as the teacher head-mounted audio device directly allows the student head-mounted audio device corresponding to a specific student to access the reverse link through the IBISC PDU carrying the first control information whose type is the access permit in order enter the Q&A mode. Specifically, in order to enter the Q&A mode, the teacher may convert the student's name to the device address of the student head-mounted audio device via the voice recognition function of the teacher head-mounted audio device, and then cause the student head-mounted audio device corresponding to that device address to access the reverse link via the IBISC PDU carrying the first control information whose type is the access permit. Alternatively, the teacher can enter the device address of the student head-mounted audio device directly via the keyboard.

In this application scenario, the preempting mode can be understood as an opportunity for a student to enter the Q&A mode by transmitting IBISC PDU carrying the first control information whose type is the random access through the teacher head-mounted audio device, and allowing the student to gain access to the reverse link by transmitting IBISC PDU carrying the second control information whose type is the access request. Specifically, in one case, the teacher head-mounted audio device selects the student head-mounted audio device that is the first to send the IBISC PDU carrying the second control information whose type is the access request or any one of the student head-mounted audio devices that sends the IBISC PDU carrying the second control information whose type is the access request as the target slave device, and sends the IBISC PDU carrying the first control message whose type is the access permit to enable the selected target slave device to access the reverse link.

At the end of the Q&A mode, the student can actively trigger the transmitting of the IBISC PDU carrying the first control information whose type is the access termination by pressing a key on the student head-mounted audio device to exit the reverse link and end the Q&A mode. The teacher can trigger the transmitting of the first control information whose type is the access termination by pressing a key on the teacher head-mounted audio device to exit the reverse link and end the Q&A mode. After the teacher head-mounted audio device and the student head-mounted audio devices exit the reverse link and end the Q&A mode, they return to the teaching mode.

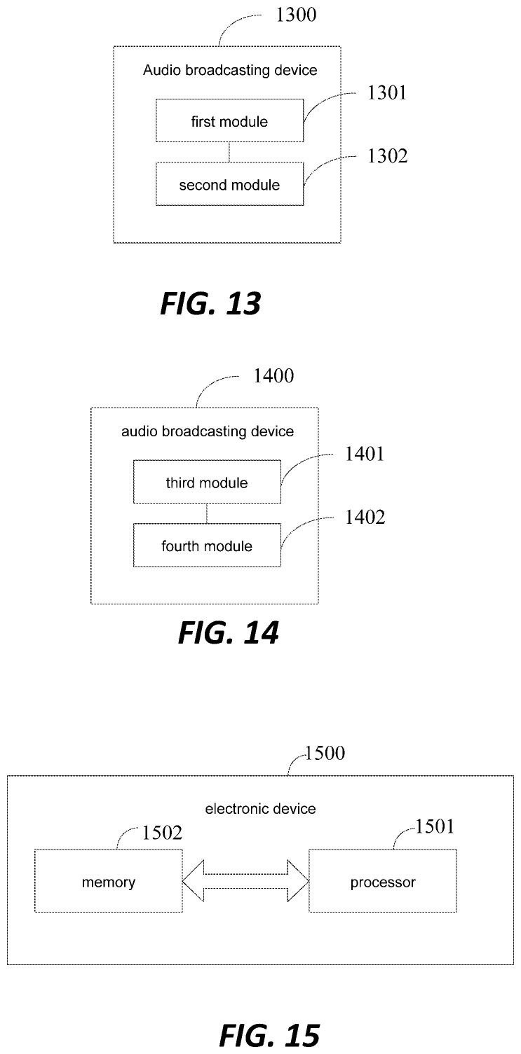

Refer to FIG. 13, an audio broadcasting device 1300 is provided according to one embodiment of the present invention. Since the audio broadcasting device 1300 solves the problem in a similar way to the method for broadcasting audio in the embodiment shown in FIG. 1, the implementation of this audio broadcasting device 1300 can be seen in the implementation of the method, and the repetition will not be repeated.

As shown in FIG. 13, the audio broadcasting device 1300 is a master device. The master device communicates with at least one slave device based on a plurality of isochronous intervals. Each isochronous interval comprises a plurality of sub-event time slots for broadcasting audio data packets. The audio broadcasting device 1300 comprises: a first module 1301 for receiving a first audio data packet broadcast by a target slave device based on a reverse link in one or more reverse link time slots, the target slave device being one of the at least one slave device that has been allowed by the master device to access the reverse link, one or more of the sub-event time slots in the isochronous interval being used as the one or more reverse link time slots when the reverse link is enabled; a second module 1302 for broadcasting a second audio data packet based on the forward link in the forward link time slots, one or more of the sub-event time slots in the isochronous interval being used as one or more forward link time slots when the forward link is enabled. At least one of the sub-event time slots is used as the reverse link time slot and the forward link time slot respectively in two isochronous intervals.

Optionally, the isochronous intervals also comprise synchronization time slots. The audio broadcasting device 1300 further comprises: a broadcast module for broadcasting synchronization information in the synchronization time slot. The synchronization information is configured to synchronize the slave device with the master device. Optionally, the isochronous interval further comprises a forward control time slot and a reverse control time slot. The audio broadcasting device 1300 further comprising: a fifth module for broadcasting a first control data packet in the forward control time slot and receiving a second control data packet sent by at least one of the slave devices in the reverse control time slot. The first control data packet is configured for triggering at least one of the slave devices to perform an operation of accessing the reverse link. The second control data packet is configured for the slave device to request access to the reverse link.

Optionally, the first control data packet carries a first control information. A type of the first control information is an access permit or a random access. When the type of the first control information is the access permit, the first control data packet is configured to trigger the slave device to perform the operation to access the reverse link. When the type of the first control information is the random access, the first control data packet is configured to identify that a random access window of the master device is open with a target time length, so as to trigger at least one of the slave devices to perform the operation to access the reverse link within the target time length.

Optionally, the audio broadcasting device 1300 further comprises: a sixth module for enabling the forward link or the reverse link and broadcasting an indicator for indicating that the forward link or the reverse link is enabled. Optionally, the packet header of the second audio data packet comprises a first region for indicating that the forward link or the reverse link is enabled. The master device broadcasts the second audio data packet comprising the first region in the forward link time slot based on the forward link to notify the slave devices to enable the reverse link or enable the forward link.

Optionally, the data packet is generated based on a BLE BIS PDU, and the packet header of the data packet further comprises: a Logical Link Identifier for identifying a load type of this data packet; a control sub-event sequence number for identifying a sequence number of this control data packet; a control sub-event transmission flag for identifying whether the control data packet is transmitted at this isochronous interval; and a load length identifier for identifying a load length of this data packet. The master device and slave device communicate wirelessly based on an interactive broadcast isochronous stream link comprising the forward link and the reverse link, both the forward link and the reverse link are unidirectional wireless broadcast data links. Optionally, each isochronous interval comprises N sub-event time slots, and N is a positive integer.

The first X sub-event time slots in the N sub-event time slots within one isochronous interval are used as the forward link time slots and the last N-X sub-event time slots in the N sub-event time slots within the one isochronous interval are used as the reverse link time slots when the reverse link is enabled, wherein X is a positive integer less than N, the master device switches to the reverse link to receive the first audio data packet broadcast by the target slave device based on the reverse link after broadcasting the second audio data packet based on the forward link in the first X sub-event time slots. The master device broadcasts the second audio data packet based on the forward link in the N sub-event time slots when the forward link is enabled. The audio broadcasting device 1300 provided by the embodiments of the present invention can perform the above embodiments of the method as shown in FIG. 1, which are similar in terms of principle and technical effect, and will not be repeated herein.

Refer to FIG. 14, the audio broadcasting device 1400 is provided according to one embodiment of the present invention. Since the principle of the audio broadcasting device 1400 for solving problems is similar to the audio broadcasting method in the embodiment shown in FIG. 7, the implementation of this audio broadcasting device 1400 can be seen in the implementation of the method, and the repetition will not be repeated.

The audio broadcasting device 1400 is a slave device. The slave device communicates with the master device based on a plurality of isochronous intervals. Each isochronous interval comprises a plurality of sub-event time slots. The audio broadcasting device 1400 comprises: a third module 1401 for broadcasting a first audio data packet broadcast by a target slave device based on a reverse link in one or more reverse link time slots after one of at least one slave device accesses the reverse link as the target slave device, the target slave device being one of the at least one slave device that has been allowed by the master device to access the reverse link, one or more of the sub-event time slots in the isochronous interval being used as the one or more reverse link time slots when the reverse link is enabled; a fourth module 1402 for receiving a second audio data packet broadcast by the master device based on a forward link in one or more forward link time slots, one or more of the sub-event time slots in the isochronous interval used as one or more forward link time slots when the forward link is enabled. At least one of the sub-event time slots is used as the reverse link time slot and the forward link time slot respectively in two isochronous intervals.

Optionally, the audio broadcasting device 1400 further comprises: a first receiving module for receiving the first audio data packet broadcast by the target slave device based on the reverse link in the one or more reverse link time slots when the reverse link is enabled and the audio broadcasting device does not access the reverse link. Optionally, the audio broadcasting device 1400 further comprises: a seventh module for searching for synchronization information broadcast by the master device and synchronizing with the master device based on the synchronization information; a second receiving module for receiving the second audio data packet based on the synchronization information; an eighth module for broadcasting the first audio data packet based on the synchronization information when accessing the reverse link as the target slave device and the reverse link is enabled, or, receiving the first audio data packet broadcast by the target slave device based on the synchronization information when not accessing the reverse link and the reverse link is enabled. Optionally, the synchronization information comprises a time slot structure and a channel information of the isochronous interval.

The slave device follows the channel information under the time slot structure of the isochronous interval, receives the second audio data packet broadcast by the master device based on the forward link and the first audio data packet broadcast by the target slave device based on the reverse link, and accesses the reverse link as the target slave device and broadcasts the first audio data packet. Optionally, the packet header of the first audio data packet and the second audio data packet comprises a second region for representing the sender of this audio data packet.

The slave device determines whether the received audio data packet is the second audio data packet sent by the master device or the first audio data packet sent by the target slave device based on the second region. Optionally, one isochronous interval comprises N the sub-event time slots, and N is a positive integer.

The first X sub-event time slots in the N sub-event time slots within one isochronous interval are used as the forward link time slots and the last N-X sub-event time slots in the N sub-event time slots within the one isochronous interval are used as the reverse link time slots when the reverse link is enabled, wherein X is a positive integer less than N. The slave device accessing the reverse link as the target slave device receives the second audio data packet based on the forward link during the first X sub-event time slots, then switches to the reverse link and broadcasts the first audio data packet based on the reverse link in the last N-X sub-event time slots. The slave devices that do not access the reverse link, receive the second audio data packet broadcasted by the master device in the first X sub-event time slots, and receive the first audio broadcasted by the target slave device in the last N-X sub-event time slots.

When the forward link is enabled, the slave device receives the second audio packet broadcast by the master device in the N sub-event time slots based on said forward link. The audio broadcasting device 1400 may perform the above embodiments of the method as shown in FIG. 7, which are similar in terms of realization principles and technical effects, and will be not described herein.

Referring to FIG. 15, an electronic device 1500 is provided according to one embodiments of the present invention. The electronic device 1500 comprises a processor 1501, a memory 1502, a program stored on the memory 1502 and runnable on the processor 1501. The program is executed by the processor 1501 to realize the various processes of the above embodiments of the audio broadcasting method and can achieve the same technical effect. To avoid repetition, it will not be repeated here.

A readable storage medium is provided according to one embodiment of the present invention. The readable storage medium store a program. The program is executed by a processor to realize the various processes of the embodiments of the above-described audio broadcasting method, and can achieve the same technical effect. To avoid repetition, it will not be repeated here. The readable storage medium may be, such as a Read-Only Memory (ROM), a Random Access Memory (RAM), a magnetic disc or a compact disc.

Those skilled in the art should be aware that the embodiments of this application may be methods, systems, or computer program products. Accordingly, the present invention may take the form of a complete hardware embodiment, a complete software embodiment, or an embodiment in conjunction with software and hardware aspects. Furthermore, the present invention may take the form of a computer program product implemented on one or more computer-available storage media (comprising, but not limited to, disk memory, CD-ROM, optical memory, etc.) containing computer-available program code.

The present invention is described with reference to methods, equipment (systems), and flow charts and/or block diagrams of computer program products according to the embodiment of the present invention. It should be understood that each flow and/or block in a flowchart and/or block diagram, as well as the combination of flow and/or block in a flowchart and/or block diagram, can be implemented by computer program instructions. These computer program instructions may be provided to a processor of a general purpose computer, a dedicated computer, an embedded processor, or other programmable data processing device to produce a machine such that instructions executed by a processor of a computer or other programmable data processing device produce instructions for implementing a flow chart or more. A device for processes and/or block diagrams or functions specified in a box or multiple boxes.

These computer program instructions may also be stored in a computer-readable memory that may guide a computer or other programmable data processing device to work in a particular way, such that the instructions stored in the computer-readable memory generate a manufacturer comprising an instruction device that is implemented in a flow chart one or more processes. Process and/or block diagram, a box or function specified in multiple boxes.

These computer program instructions may also be loaded on a computer or other programmable data processing device such that a series of operational operations are performed on a computer or other programmable device to produce computer-implemented processing, thereby providing instructions executed on a computer or other programmable device for implementing a flow chart. The operations of a process or multiple processes and/or block diagrams, or functions specified in a box.

Although preferred embodiments of the present invention have been described, additional changes and modifications to these embodiments may be made once the basic creative concepts are known to those skilled in the art. The appended claims are therefore intended to be interpreted to comprise preferred embodiments and all changes and modifications falling within the scope of this application.

I claim:

1. A method for broadcasting audio, applied to a master device communicating with at least one slave device based on a plurality of isochronous intervals each including a plurality of sub-event time slots for broadcasting audio data packets, the method comprising:
receiving, by the master device, a first audio data packet broadcast by a target slave device based on a reverse link in one or more reverse link time slots, the target slave device being one of the at least one slave device that has been allowed by the master device to access the reverse link, one or more of the sub-event time slots in the isochronous interval being used as the one or more reverse link time slots, when the reverse link is enabled; and
broadcasting, by the master device, a second audio data packet based on a forward link in one or more forward link time slots, one or more of the sub-event time slots in the isochronous interval being used as one or more forward link time slots, when the forward link is enabled, wherein at least one of the sub-event time slots is used as the reverse link time slot and the forward link time slot respectively in two isochronous intervals.

2. The method according to claim 1, wherein the isochronous interval further comprises a synchronization time slot, the method further comprises:
broadcasting a synchronization information in the synchronization time slot by the master device, wherein the synchronization information is configured to synchronize the slave device with the master device.

3. The method according to claim 1, wherein the isochronous interval further comprises a forward control time slot and a reverse control time slot; the method further comprises:
broadcasting a first control data packet in the forward control time slot and receiving a second control data packet sent by at least one of the slave devices in the reverse control time slot by the master device, wherein the first control data packet is configured to trigger at least one of the slave devices to perform an operation of accessing the reverse link, and the second control data packet is configured for the slave device to request access to the reverse link.

4. The method according to claim 3, wherein the first control data packet carries a first control information, a type of the first control information is an access permit or a random access;
the first control data packet is configured to trigger the slave device to perform the operation of accessing the reverse link when the type of the first control information is the access permit, and
the first control data packet is configured to identify that a random access window of the master device is opened within a target time length, so as to trigger at least one slave device to perform the operation of accessing the reverse link within the target time length when the type of the first control information is the random access.

5. The method according to claim 1, further comprising:
enabling the forward link or the reverse link and broadcasting an indicator for indicating that the forward link or the reverse link is enabled by the master device.

6. The method according to claim 5, wherein a packet header of the second audio data packet comprises a first region for indicating that the forward link or the reverse link is enabled, the master device broadcasts the second audio data packet comprising the first region based on the forward link in the forward link time slot to notify the slave device that the reverse link or the forward link is enabled.

7. The method according to claim 6, wherein both the audio data packet and the control data packet are generated based on a BLE BIS PDU, and the packet header of the audio data packet and the control data packet further comprises:
a Logical Link Identifier for identifying a load type of this data packet;
a control sub-event sequence number for identifying a sequence number of this control data packet;
a control sub-event transmission flag for identifying whether the control data packet is transmitted at this isochronous interval; and
a load length identifier for identifying a load length of this data packet;
the master device and slave device communicate wirelessly based on an interactive broadcast isochronous stream link comprising the forward link and the reverse link, both the forward link and the reverse link are unidirectional wireless broadcast data links.

8. The method according to claim 1, wherein an isochronous interval comprises N sub-event time slots, N is a positive integer;
first X sub-event time slots in the N sub-event time slots within one isochronous interval are used as the forward link time slots and last N-X sub-event time slots in the N sub-event time slots within the one isochronous interval are used as the reverse link time slots, the master device switches to the reverse link to receive the first audio data packet broadcast by the target slave device based on the reverse link after broadcasting the second audio data packet based on the forward link in the first X sub-event time slots, when the reverse link is enabled, wherein X is a positive integer less than N; and
the master device broadcasts the second audio data packet based on the forward link in the N sub-event time slots when the forward link is enabled.

9. A method for broadcasting audio, applied to a slave device communicating with a master device based on a plurality of isochronous intervals each comprising a plurality of sub-event time slots, comprising:
broadcasting a first audio data packet broadcast by a target slave device based on a reverse link in one or more reverse link time slots after one of at least one slave device accesses the reverse link as the target slave device, the target slave device being one of the at least one slave device that has been allowed by the master device to access the reverse link, one or more of the sub-event time slots in the isochronous interval being used as the one or more reverse link time slots, when the reverse link is enabled;
receiving a second audio data packet broadcast by the master device based on a forward link in one or more forward link time slots, one or more of the sub-event time slots in the isochronous interval being used as one or more forward link time slots, when the forward link is enabled, wherein at least one of the sub-event time slots is used as the reverse link time slot and the forward link time slot respectively in two isochronous intervals.

10. The method according to claim 9, further comprising: receiving, by the slave device that does not access the reverse link, the first audio data packet broadcast by the target slave device based on the reverse link in the one or more reverse link time slots, when the reverse link is enabled.

11. The method according to claim 10, further comprising:
searching for synchronization information broadcast by the master device and synchronizing with the master device based on the synchronization information;
receiving the second audio data packet based on the synchronization information;
broadcasting the first audio data packet based on the synchronization information when the slave device accesses the reverse link as the target slave device and the reverse link is enabled, or, receiving the first audio data packet broadcast by the target slave device based on the synchronization information when the slave device does not access the reverse link and the reverse link is enabled.

12. The method according to claim 11, wherein the synchronization information comprises a time slot structure and a channel information of the isochronous interval, the slave device follows the channel information under the time slot structure of the isochronous interval, receives the second audio data packet broadcast by the master device based on the forward link and the first audio data packet broadcast by the target slave device based on the reverse link, and accesses the reverse link as the target slave device and broadcasts the first audio data packet.

13. The method according to claim 9, wherein a packet header of the first audio data packet and the second audio data packet comprises a second region for representing a sender of this audio data packet, the slave device determines that the received audio data packet is the second audio data packet sent by the master device or the first audio data packet sent by the target slave device based on the second region.

14. The method according to claim 11, wherein an isochronous interval comprises N sub-event time slots, N is a positive integer, first X sub-event time slots in the N sub-event time slots within one isochronous interval are used as the forward link time slots and last N-X sub-event time slots in the N sub-event time slots within the one isochronous interval are used as the reverse link time slots, when the reverse link is enabled, wherein X is a positive integer less than N,
when the slave device accesses the reverse link as the target slave device, it receives the second audio packet broadcast by the master device based on the forward link in the first X sub-event slots, then switches to the reverse link to broadcast the first audio packet based on the reverse link in the last N-X sub-event slots; when the slave device does not access the reverse link, it receives the second audio packet broadcast by the master device in the first X sub-event slot, and receives the first audio packet broadcast by the target slave device in the last N-X sub-event slot,
the slave device receives the second audio packet broadcast by the master device based on the forward link in the N sub-event time slots when the forward link is enabled.

15. An audio broadcasting device being a master device communicating with at least one slave device based on a plurality of isochronous intervals each comprising a plurality of sub-event time slots, comprising:
a first module for receiving a first audio data packet broadcast by a target slave device based on a reverse link in one or more reverse link time slots, the target slave device being one of the at least one slave device that has been allowed by the master device to access the reverse link, one or more of the sub-event time slots in the isochronous interval being used as the one or more reverse link time slots, when the reverse link is enabled;
a second module for broadcasting a second audio data packet based on a forward link in one or more forward link time slots, one or more of the sub-event time slots in the isochronous interval being used as one or more forward link time slots, when the forward link is enabled, wherein at least one of the sub-event time slots is used as the reverse link time slot and the forward link time slot respectively in two isochronous intervals.

16. The audio broadcasting device according to claim 15, wherein the isochronous interval further comprises a synchronization time slot, the audio broadcasting device further comprises:
a broadcast module for broadcasting a synchronization information in the synchronization time slot, wherein the synchronization information is configured to synchronize the slave device with the master device.

17. The audio broadcasting device according to claim 15, wherein the isochronous interval further comprises a forward control time slot and a reverse control time slot; the audio broadcasting device further comprises:
a fifth module for broadcasting a first control data packet in the forward control time slot and receiving a second control data packet sent by at least one of the slave devices in the reverse control time slot by the master device;
wherein the first control data packet is configured to trigger at least one of the slave devices to perform an operation of accessing the reverse link, and the second control data packet is configured for the slave device to request access to the reverse link.

18. The audio broadcasting device according to claim 17, wherein
the first control data packet carries a first control information, a type of the first control information is an access permit or a random access;
the first control data packet is configured to trigger the slave device to perform the operation of accessing the reverse link when the type of the first control information is the access permit, and
the first control data packet is configured to identify that a random access window of the master device is opened within a target time length, so as to trigger at least one slave device to perform the operation of accessing the reverse link within the target time length when the type of the first control information is the random access.

19. The audio broadcasting device according to claim 15, further comprising:
a sixth module for enabling the forward link or the reverse link and broadcasting an indicator for indicating that the forward link or the reverse link is enabled by the master device.

20. The audio broadcasting device according to claim 15, wherein a packet header of the second audio data packet comprises a first region for indicating that the forward link or the reverse link is enabled;
the master device broadcasts the second audio data packet comprising the first region based on the forward link in the forward link time slot to notify the slave device that the reverse link or the forward link is enabled.
